(19) United States
(12) Patent Application Publication
(10) Pub. No.: US 2008/0285906 A1
(43) Pub. Date: Nov. 20, 2008

(54) Bearing Set with an Angular Ball Bearing and Cylinder Roller Bearing Receiving Axial Forces

(75) Inventors: Jan Georgi, Niederwerrn (DE); Rainer Moller, Stammheim (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/094,068

(22) PCT Filed: Nov. 14, 2006
(86) PCT No.: PCT/DE2006/001986

§ 371 Date: Jul. 23, 2008

(30) Foreign Application Priority Data
Nov. 17, 2005 (DE) 10 2005 054 705.2

(51) Int. Cl. F16C 19/30; F16C 19/04

(52) U.S. Cl. 384/618; 384/490

(57) ABSTRACT

The invention relates to a bearing set for a shaft to be guided in an axially restricted and exact manner, a running wheel or the like for machine units. The aim of the invention is to devise less expensive bearings for receiving comparatively low axial back pressure forces. The bearing set consists of an angular ball baring receiving axial pressure forces due to operation, and a cylinder roller bearing configured as a support bearing and receiving axial back pressure forces.

### FIELD OF THE INVENTION

The invention relates to a bearing set for a shaft or the like which requires tight and exact axial guidance, such as for example a rotor or some other machine unit.

### BACKGROUND OF THE INVENTION

In all fields of mechanical engineering in which a rotor, such as a fan impeller, or the like requires very tight axial guidance with respect to the surrounding structure, in particular in the bearing arrangement of shafts which require very exact axial guidance, such as for example in gearing shafts, use is made of bearing sets composed of a plurality of bearing types.

Use is often made of a bearing set composed of a four-point bearing—a so-called QJ bearing—and an external-rim radial bearing—a so-called NU bearing. A bearing combination of said type is known for example from the publication WL 00 200/5 DA page 150 from the company FAG OEM und Handel AG. Here, said combination is used in a combined step-down and doffing cylinder gearing for the bearing arrangement of a shaft.

A disadvantage here is that standard four-point bearings are only available with a pressure angle of 35°. Four-point bearings are also comparatively expensive.

Also known is a mounting of shafts in which the bearing set is composed of an angular-contact ball bearing pair in an X-arrangement or O-arrangement and an NU axial bearing. A bearing set of said type is described for example in the publication no. WL 00 200/4 DA page 163 from the company FAG Kugelfischer Georg Schäfer KGaA. Here, use is made of such a combination composed of two multi-row cylindrical roller bearings and two angular-contact ball bearings set in an X-arrangement in the bearing arrangement of a working roll.

Primarily in applications which have a directional axial force during operation, and in which an axial back pressure force, which prevails over the axial operating pressure force, is generated only in specific operating states which occur for a short proportion of time, for example when starting up and shutting down a system, it is not necessary to use a fully-rated and expensive axial back pressure bearing.

### OBJECT OF THE INVENTION

Against this background, it is the object of the invention to create a bearing set for a shaft, a rotor or the like, which requires tight and exact axial guidance, for machine units, for example for a gearing shaft, in which the back pressure forces which occur in small magnitude are absorbed in a bearing of little expense.

### SUMMARY OF THE INVENTION

The invention is based on the realization that back pressure forces which occur during the operation of a machine unit often occur for a comparatively small proportion of time and with a small magnitude, which can be absorbed by a simpler bearing.

The set object is achieved according to the features of the main claim by using a bearing set which is composed of a radially free angular-contact ball bearing, which absorbs operational axial forces, and a cylindrical roller bearing which absorbs occurring back pressure forces and which is embodied as a thrust bearing.

The subclaims describe preferred refinements or embodiments of the invention. Accordingly, it is firstly provided that the cylindrical roller bearing is embodied as an NJ cylindrical roller bearing.

According to a further embodiment of the bearing set according to the invention, a very small axial play is formed between the inner ring of the angular-contact ball bearing and the inner ring of the NJ cylindrical roller bearing.

By means of the solution according to the invention, exact guidance between a shaft, a rotor or the like and a housing of a machine unit in which said components require axially tight and exact guidance is obtained in particular by means of the very small axial play between the inner rings of the angular-contact ball bearing and of the NJ cylindrical roller bearing which is embodied as a rim-type plain bearing.

The pressure force which usually occurs during operation of the machine unit is absorbed by means of the angular-contact ball bearing. The back pressure forces which however occur comparatively rarely and with a low magnitude are in contrast absorbed by the rim of the NJ cylindrical roller bearing.

Although the NJ cylindrical roller bearing with the additional rim is slightly more expensive to produce than an NU axial bearing in conventional solutions, a QJ four-point bearing is however comparatively very much more expensive than an angular-contact ball bearing, so that the bearing set according to the invention results in an overall cost saving.

Said cost saving is increased further if, in comparison with conventional solutions, even an entire bearing is omitted.

### BRIEF DESCRIPTION OF THE DRAWINGS

The invention is explained in more detail below on the basis of the appended drawings of an embodiment. In the drawings, in detail:

FIG. 1 shows a sectioned side view of a conventional bearing set as per the prior art, and

FIG. 2 shows a sectioned side view of a bearing set designed according to the invention.

### DETAILED DESCRIPTION OF THE DRAWINGS

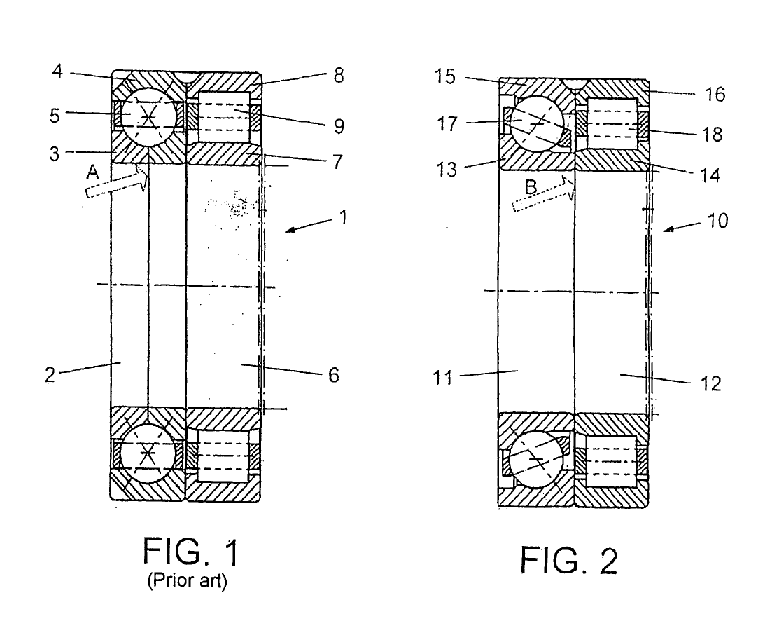

The bearing set 1 as per the prior art shown in FIG. 1 is composed of a QJ bearing 2, embodied as a four-point bearing, with balls 5 situated between an inner ring 3 and an outer ring 4 and with an NU axial bearing 6 which is embodied as an external-rim bearing and which has cylindrical rollers 9 guided between an inner ring 7 and an outer ring 8. Here, the axial play is set as per the arrow A in the four-point bearing.

The bearing set 10 as per FIG. 2 is composed, according to the invention, of an angular-contact ball bearing 11 and an NJ cylindrical roller bearing 12 which is embodied as a thrust bearing. The two bearings 11 and 12 have in each case one inner ring 13 and 14 and in each case one outer ring 15 and 16, between which are held the balls 17 and cylindrical rollers 18 respectively.

A very small axial play as per the arrow B is formed between the inner ring 13 of the angular-contact ball bearing 11 and the inner ring 14 of the NJ cylindrical roller bearing 12. This ensures exact guidance between the component, which is guided in the bearings 11 and 12 but is not illustrated, and the surrounding housing (not shown).

The operational pressure forces are absorbed by the angular-contact ball bearing 11. The occasionally-occurring low back pressure forces are absorbed by the NJ cylindrical roller bearing 12.

### LIST OF REFERENCE SYMBOLS

1 Bearing set
2 QJ bearing
3 Inner ring
4 Outer ring
5 Ball
6 NU axial bearing
7 Inner ring
8 Outer ring
9 Cylindrical roller
10 Bearing set
11 Angular contact ball bearing
12 NJ cylindrical roller bearing
13 Inner ring
14 Inner ring
15 Outer ring
16 Outer ring
17 Ball
18 Cylindrical roller
A Axial play
B Axial play

1. A bearing set for a shaft, which requires tight and exact axial guidance, for machine units, comprising: an angular-contact ball bearing, which absorbs operational pressure forces, and a cylindrical roller bearing which absorbs occurring back pressures and which is embodied as a thrust bearing.

2. The bearing set as claimed in claim 1, wherein the cylindrical roller bearing is embodied as an NJ cylindrical roller bearing.

3. The bearing set as claimed in claim 1, wherein a very small axial play is formed between the inner ring of the angular-contact ball bearing and the inner ring of the NJ cylindrical roller bearing.
